(19) United States
(12) Patent Application Publication
(10) Pub. No.: US 2026/0338272 A1
(43) Pub. Date: Oct. 29, 2026

(54) MANUALLY OPERATED ACTUATOR AND METHOD FOR CONTROLLING A MANUALLY OPERATED ACTUATOR

(71) Applicant: Dr. Ing. h.c. F. Porsche Aktiengesellschaft, Stuttgart (DE)

(72) Inventors: Manuel KÜHNER, Petersberg (Marbach) (DE); Simon LIPPHARDT, Holzgerlingen (DE); Karsten SCHULT, Reutlingen (DE)

(21) Appl. No.: 19/661,737

(22) Filed: Apr. 29, 2026

(30) Foreign Application Priority Data
Apr. 29, 2025 (DE) 10 2025 116 506.8

(51) Int. Cl. F16H 59/02; F16H 59/04

(52) U.S. Cl. CPC F16H 59/0204; F16H 59/044; F16H 2059/048

(57) ABSTRACT

A manually operated actuator is for an emulated actuation of a transmission of a motor vehicle. The actuator includes an actuator housing and an actuating lever pivotably mounted in the actuator housing along a first actuation direction and along a second actuation direction. In a first mode, the actuating lever is configured to be displaced in a shift gate along the first actuation direction and transversely to the shift gate in the second actuation direction, and, in a second mode, the actuating lever is configured to be displaced in the shift gate along the first actuation direction. A displaceability transversely to the shift gate in the second actuation direction is limited or prevented by a controllable limiter.

### CROSS REFERENCE TO RELATED APPLICATIONS

This application claims benefit to German Patent Application No. DE 10 2025 116 506.8, filed on Apr. 29, 2025, which is hereby incorporated by reference herein.

### FIELD

The present disclosure relates to a manually operated actuator and a method for controlling a manually operated actuator, in particular for a motor vehicle.

### BACKGROUND

Motor vehicles often include, for example, a shift lever for shifting a manual transmission or a selector lever for operating an automatic transmission. The shift lever is mechanically coupled to the manual transmission to shift the gears of the manual transmission. Such a motor vehicle also comprises a clutch in the powertrain and a clutch pedal for actuating the clutch. In comparison, a motor vehicle with an automatic transmission does not have a clutch to be actuated by the driver, and correspondingly does not have a clutch pedal either. The selector lever is mechanically coupled to the automatic transmission.

In modern motor vehicles, such a shift lever and such a selector lever are typically increasingly omitted and replaced with operating buttons, which saves costs and allows automated, electronically controlled operation of the automatic transmission. However, fully automated control of motor vehicles is not desired by every driver because it also makes individual driver intervention more difficult or prevents it, which is still preferred by some drivers.

### SUMMARY

In an embodiment, the present disclosure provides a manually operated actuator for an emulated actuation of a transmission of a motor vehicle. The actuator includes an actuator housing and an actuating lever pivotably mounted in the actuator housing along a first actuation direction and along a second actuation direction. In a first mode, the actuating lever is configured to be displaced in a shift gate along the first actuation direction and transversely to the shift gate in the second actuation direction, and, in a second mode, the actuating lever is configured to be displaced in the shift gate along the first actuation direction. A displaceability transversely to the shift gate in the second actuation direction is limited or prevented by a controllable limiter.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic illustration of an embodiment of a manually operated actuator with an actuating lever of a motor vehicle for explaining the invention;

FIG. 2 is a further schematic illustration of an embodiment of a manually operated actuator with an actuating lever of a motor vehicle for explaining the invention;

FIG. 3 is a schematic illustration of a plurality of shift gates, wherein the actuating lever is displaceably mounted in a first mode both along the shift gates and transversely to the shift gates; and

FIG. 4 is a schematic illustration of a plurality of shift gates, wherein the actuating lever is displaceably mounted in a second mode only along a shift gate and essentially not transversely to the shift gate.

### DETAILED DESCRIPTION

There is a desire for re-manualization of motor vehicles in order to be able to perform certain functionalities manually again, for example manual operation of the automatic transmission as a manual transmission and/or sequential shifting of the automatic transmission, wherein the vehicle may also comprise only an electric motor as a drive motor, and wherein the shifting of a manual transmission or an automatic transmission is emulated.

However, this may require that a manually operated actuator is provided and usable, which is equipped with an actuating lever with which, in a first mode, the respective manual actuation of a manual shiftable transmission and/or, in a second mode, sequential shifting of an automatic transmission can be performed in a simulated manner, so that the manually operated actuator is suitable both for shifting an automatic transmission and for shifting an automatic transmission in the manner of a manual transmission, or can emulate this. In the first mode, the actuating lever is movable in a plurality of shift gates and also movable transversely to these shift gates, whereas, in contrast, the actuating lever in the second mode is essentially movable only in one shift gate, wherein the displacement of the actuating lever transversely to the one shift gate should be virtually blocked.

The driver is thus to have the choice as to whether to drive the vehicle and shift the existing transmission, or, in an electric vehicle, an existing electric motor, as if a manual transmission or an automatic transmission were provided. An electronically controllable clutch pedal may also be provided to emulate clutch actuation with an emulated manual transmission.

However, it is also desirable for the manually operated actuator to be suitably controllable in order to provide the operator or the driver of the motor vehicle with a realistic experience of shifting a manual transmission or an automatic transmission.

Embodiments of the present disclosure provide a manually operated actuator equipped with an actuating lever which has suitable actuation feel in various actuation modes. Embodiments of the present disclosure provide an improved method for controlling a manually operated actuator, which allows suitable actuation feel in different actuation modes.

An embodiment of the present disclosure relates to a manually operated actuator, in particular embodiments for the emulated actuation of a transmission, in particular of a motor vehicle, with an actuator housing and an actuating lever, wherein the actuating lever is pivotably mounted in the actuator housing along at least one first actuation direction and along a second actuation direction, such that, in a first mode, the actuating lever can be displaced in shift gates along the first actuation direction and transversely to the shift gates in the second actuation direction, and, in a second mode, the actuating lever can be displaced in a shift gate along the first actuation direction, wherein the displaceability transversely to the shift gate in the second actuation direction is limited or prevented by a controllable limiting element (also referred to herein as a limiter). Thus, the actuation haptics of a shift lever for a manual transmission and a selector lever for an automatic transmission can be selected and actuated in a controlled manner.

In a further embodiment of the present disclosure, it is also expedient if the controllable limiting element is formed with two lateral limiting walls, between which the actuating lever can be arranged to restrict and/or prevent its displaceability in the second actuating direction. Thus, the limiting element can be moved to engage the actuating lever in order to restrict its displaceability. The limiting walls serve as stops for the displaceability.

It is also expedient if the controllable limiting element is formed as a rail-like element with the two lateral limiting walls. Thus, a stable design is achieved that is suitable for limiting the actuating lever in its displaceability, even if the driver or operator pulls or pushes on the actuating lever and exerts a not insignificant force on the actuating lever.

In a further embodiment present disclosure, it is also advantageous if the controllable limiting element is formed as a U-shaped rail in cross section with the two lateral limiting walls. Thus, a very stable design is achieved that is suitable for limiting the actuating lever in its displaceability, even if the driver or operator pulls or pushes on the actuating lever and exerts a not insignificant force on the actuating lever.

It is also advantageous if the limiting element can be raised and lowered, wherein the limiting element releases the actuating lever in a first operating position and wherein the limiting element positions the actuating lever between the limiting walls in a second operating position and limits or prevents its movement in one direction. In this respect, the term “raising” or “lowering” is meant relative to a normal direction, such as in the direction of gravity or opposite the direction of gravity, wherein an angle thereto is also possible. Instead of the direction of gravity, the z-direction can also be meant as the vertical direction of a motor vehicle.

It is also advantageous if an adjustment actuator is provided for raising and lowering the limiting element. Thus, a controlled restriction of the displaceability of the actuating lever can be achieved.

It is particularly advantageous if at least one controllable actuator is provided, which exerts a force effect on the actuating lever in order to influence the resistive forces acting on the actuating lever during actuation of the actuating lever, in order to influence the actuation feel of the actuating lever, wherein at least one transmission is provided between the actuating lever and the at least one actuator, which is equipped with a variably adjustable backlash, such that the backlash between the actuating lever and the actuator is controllably adjustable, or alternatively that two controllable actuators are provided, which exert a force effect on the actuating lever in order to influence the resistive forces acting on the actuating lever during actuation of the actuating lever in a first direction and in a second direction, in order to influence the actuation feel of the actuating lever.

An embodiment of the present disclosure relates to a method for controlling a manually operated actuator, in particular embodiments according to the present disclosure, in particular for the actuation of a transmission, in particular of a motor vehicle, with an actuator housing and an actuating lever, wherein the actuating lever is pivotably mounted in the actuator housing along at least one first actuation direction and along a second actuation direction, such that, in a first mode, the actuating lever can be displaced in shift gates along the first actuation direction and transversely to the shift gates in the second actuation direction, and, in a second mode, the actuating lever can be displaced in a shift gate along the first actuation direction, wherein the displaceability transversely to the shift gate in the second actuation direction is limited or prevented by a controllable limiting element, wherein the limiting element is controlled to limit or prevent the displaceability of the actuating lever in the second actuation direction in the second mode. This enables a controlled change between two modes with different actuation feel.

It is also advantageous if the limiting element is raised and lowered, wherein the limiting element releases the actuating lever in a first operating position and wherein the limiting element positions the actuating lever between the limiting walls in a second operating position and limits or prevents its movement in one direction.

It is also advantageous if switching is carried out between the first mode and the second mode by means of a switching element, and the limiting element is raised or lowered in a controlled manner depending on the mode.

Embodiments of the present disclosure are described in detail below on the basis of an embodiment with reference to the drawings.

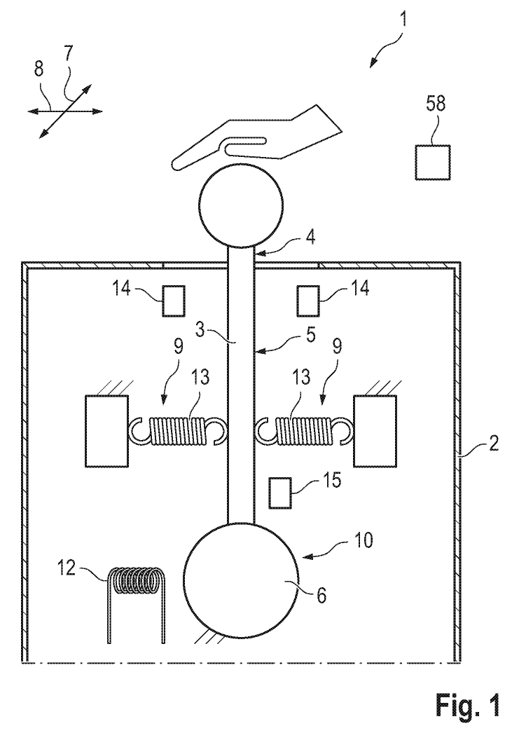

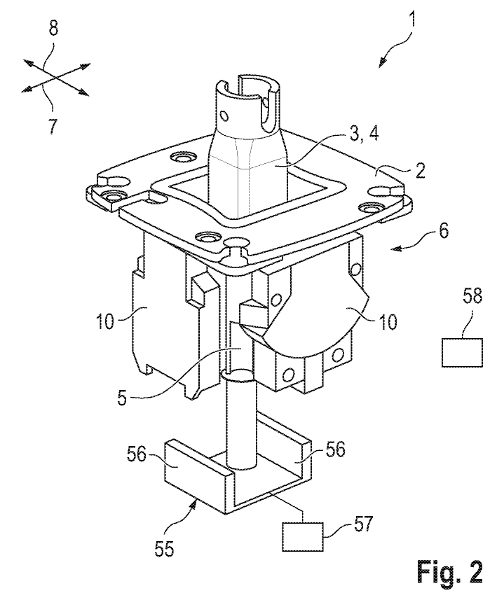

FIGS. 1 and 2 each show an embodiment of a manually operated actuator 1 of a motor vehicle in a schematic illustration. The manually operated actuator 1 is used to emulate shifting of a transmission, wherein no mechanical connection is provided between the actuating lever 3 and a transmission or an electric motor, such that shifting of a manual transmission or an automatic transmission in a vehicle with an automatic transmission or an electric motor can be performed or emulated. For this purpose, an electronically controlled clutch pedal may also be provided, which would be actuated when shifting the manual transmission.

The manually operated actuator 1 comprises an actuator housing 2 and an actuating lever 3, which is displaceably mounted in the actuator housing 2.

The actuating lever 3 typically comprises a first lever arm region 4 and a second lever arm region 5. The actuating lever 3 is pivotably mounted in the actuator housing 2 by means of a bearing 6, such that the first lever arm region 4 projects outward from the actuator housing 2, typically upward, and the second lever arm region 5 projects into the actuator housing 2.

When the actuating lever 3 is displaced, the actuating lever 3 can be displaced in the actuator housing 2 laterally in accordance with direction 7 as well as transversely in accordance with direction 8.

According to the embodiment of the manually operated actuator 1 shown in FIG. 1, at least a first spring assembly 9 is provided or a plurality of spring assemblies 9 are provided, which interact with the actuating lever 3. The respective spring assembly 9 is connected, for example, both to the actuator housing 2 and to the actuating lever 3 in order to transmit a force to the actuating lever 3 in the tensile and/or compressive direction, so that a first stable rest position is provided in the rest position or center position. The actuating lever 3 is thus arranged by means of the at least one spring assembly 9 with respect to a first stable rest position.

The tensile direction, for example, is a direction in which the respective spring assembly 9 exerts a tensile force on the actuating lever 3, and the compressive direction is a direction in which the spring assembly 9 exerts a compressive force on the actuating lever 3. In the case of two opposing spring assemblies 9, as shown in FIG. 1, the tensile and compressive directions of the respective spring assembly 9 are reversed for each spring.

According to the embodiment version shown, the spring assembly 9 comprises at least one spring element 13, which is connected to both the actuating lever 3 and the actuator housing 2, such that the actuating lever 3 is displaceably arranged against a restoring force of the spring element 13; in particular, the spring assembly 9 comprises at least two spring elements 13, which are connected to both the actuating lever 3 and the actuator housing 2, such that the actuating lever 3 is displaceably arranged against a restoring force of at least one spring element 13.

Furthermore, at least one controllable actuator 10 is arranged, which acts on the actuating lever 3. Preferably, a plurality of such actuators 10 are provided. A first actuator 10 may be provided to act in direction 7 and/or a second actuator 10 may be provided to act in direction 8. In FIG. 1, an exemplary first actuator 10 is shown, which acts on the actuating lever 3 in direction 8. This can also be implemented differently, for example with an actuator (not shown) acting in direction 7.

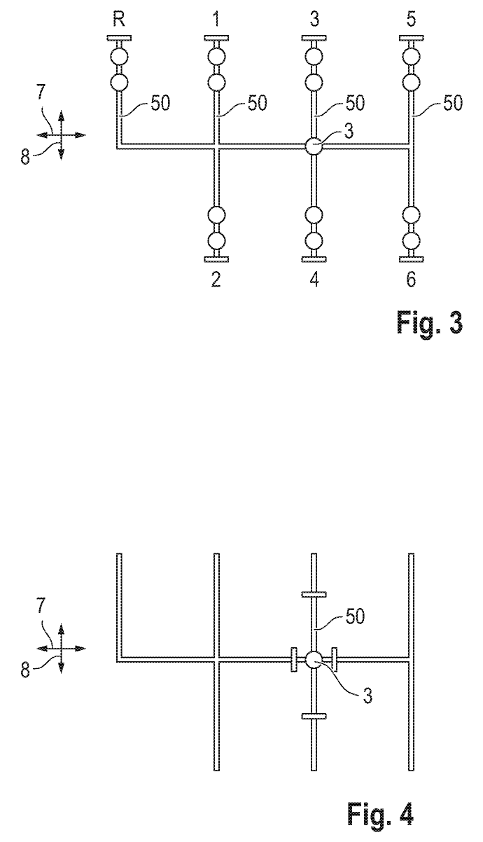

The actuating lever 3 may be displaceable in the actuator housing 2 in at least one shift gate 50, or in a plurality of shift gates 50, in the first transverse direction 8 and may be displaceable so as to be displaceable transversely to the shift gate 50 or shift gates in the second lateral direction 7. Preferably, a stable rest position is positioned in a first shift gate. In this regard, reference is made to FIGS. 3 and 4.

A schematic diagram is shown in FIG. 3 showing that, in a first mode, the actuating lever 3 is displaceable in shift gates 50 along the first actuation direction 8 and transversely to the shift gates 50 in the second actuation direction 7.

In FIG. 4, a schematic diagram is shown showing that, in a second mode, the actuating lever 3 is displaceable in only one shift gate 50 along the first actuation direction 8, wherein the displaceability of the actuating lever 3 transverse to the shift gate 50 in the second actuation direction 7 is limited or prevented by a controllable limiting element.

According to the embodiment shown, the actuating lever 3 is arranged so as to be pivotably mounted in a bearing 6 about at least one axis.

In a preferred embodiment, the at least one actuator 10 is a magnetorheological actuator or comprises such a magnetorheological actuator 10. Alternatively, the at least one actuator 10 may also be an electromechanical actuator 10, or it may be a pneumatic actuator or the like.

In the case of a magnetorheological actuator, the actuator 10 comprises at least one solenoid 12 or an electromagnet. The at least one magnetorheological actuator 10 can thereby be switched or controlled.

The actuating lever 3 is arranged in the actuator housing 2 so as to be pivotable along at least one actuation path, wherein the respective actuation path provides end stops 14 at its ends, against which the actuating lever 3 can come to rest when it is pivoted that far. However, the spring elements 13 and also the at least one actuator 10 counteract the displacement of the actuating lever 3 toward the end stops 14.

Accordingly, the at least one controllable actuator 10 is provided, which exerts a force on the actuating lever 3 in order to influence the resistance forces acting on the actuating lever 3 when actuating the actuating lever 3, in order to influence the actuation feel of the actuating lever 3. The at least one actuator 10 is an actuator 10 that brakes or blocks actuation of the actuating lever 3, wherein the magnitude of the applied force can be controlled. An actuator 10 is therefore suitable for influencing the actuation feel of the actuating lever 3.

In the embodiment shown, the actuating lever 3 is monostably mounted with respect to a rest position by means of at least one spring assembly 9 with spring elements 13. The actuating lever 3 can also be multistably arranged.

Furthermore, at least one sensor 15 is provided, by means of which the position of the actuating lever 3 is monitored. The actuating force acting on the actuating lever 3 and/or the acceleration of the actuating lever 3 can also be monitored by means of the sensor 15. This indicates how the driver moves the actuating lever 3, with what force and/or at what speed.

As already described, the actuating lever 3 is arranged so as to be pivotably mounted in the actuator housing 2 along at least a first actuating direction 8 and along a second actuating direction 7, such that the actuating lever 3 is displaceable, in a first mode (see FIG. 3), in shift gates 50 along the first actuating direction 8 and transversely to the shift gates 50 in the second actuating direction 7. Furthermore, in a second mode (see FIG. 4), the actuating lever 3 is displaceable in a shift gate 50 along the first actuating direction 8, wherein the displaceability transversely to the shift gate 50 in the second actuating direction 7 is limited or prevented by a controllable limiting element 55. Such a limiting element 55 is shown schematically in FIG. 2.

The controllable limiting element 55 is formed with two lateral limiting walls 56, between which the actuating lever 3 can be arranged to limit and/or prevent its displaceability in the second actuating direction 7, as can be seen in FIG. 2.

In the illustrated embodiment of FIG. 2, the controllable limiting element 55 is configured as a rail-like element with the two lateral limiting walls 56. In principle, the limiting element 55 can also be configured differently, for example in an annular shape with an oval opening, etc.

In the embodiment shown, the limiting element 55 is configured as a one-piece, U-shaped rail in cross section with the two lateral limiting walls 56.

To control the effect of the limiting element 55, the limiting element 55 can be raised and lowered, wherein the limiting element 55 releases the actuating lever 3 in a first operating position and wherein the limiting element 55 positions the actuating lever 3 between the limiting walls 56 in a second operating position and limits or prevents its movement in one direction 7.

An adjustment actuator 57 is provided to adjust the limiting element 55, for example, for raising and lowering. This may be electromechanical or otherwise configured.

The method according to an embodiment of the present disclosure for controlling a manually operated actuator 1, in particular for the emulated actuation of a transmission, in particular of a motor vehicle, provides that the actuating lever 3 is displaceable in a first mode, a manual shift mode, in shift gates 50 along the first actuation direction 8 and transversely to the shift gates 50 in the second actuation direction 7, and that the actuating lever 3 is displaceable in a second mode, an automatic sequential mode, in a shift gate 50 along the first actuation direction 8, wherein the displaceability transversely to the shift gate 50 in the second actuation direction 7 is limited or prevented by a controllable limiting element 55, wherein the limiting element 55 is controlled in order to limit or prevent the displaceability of the actuating lever 3 in the second actuation direction 7 in the second mode.

In the embodiment shown, the limiting element 55 is raised and lowered, depending on the mode, wherein the limiting element 55 releases the actuating lever 3 in a first operating position and wherein the limiting element 55 positions the actuating lever 3 between the limiting walls 56 in a second operating position and limits or prevents its movement in one direction 7.

It is also expedient if switching is carried out between the first mode and the second mode by means of a switching element 58, and the limiting element 55 is raised or lowered in a controlled manner depending on the mode.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 Manually operated actuator
2 Actuator housing
3 Actuating lever
4 First lever arm region
5 Second lever arm region
6 Bearing
7 Lateral direction / actuation direction
8 Transverse direction / actuation direction
9 Spring assembly
10 Actuator
12 Solenoid
13 Spring element
14 End stops
15 Sensor
50 Shift gate
55 Limiting element
56 Limiting wall
57 Adjustment actuator
58 Switching element

1. A manually operated actuator for an emulated actuation of a transmission of a motor vehicle, the manually operated actuator comprising:
an actuator housing; and
an actuating lever pivotably mounted in the actuator housing along a first actuation direction and along a second actuation direction,
wherein, in a first mode, the actuating lever is configured to be displaced in a shift gate along the first actuation direction and transversely to the shift gate in the second actuation direction, and, in a second mode, the actuating lever is configured to be displaced in the shift gate along the first actuation direction, and
wherein a displaceability transversely to the shift gate in the second actuation direction is limited or prevented by a controllable limiter.

2. The manually operated actuator according to claim 1, wherein the controllable limiter is configured with two lateral limiting walls, between which the actuating lever is configured to be arranged to limit and/or prevent the displaceability of the actuating lever in the second actuation direction.

3. The manually operated actuator according to claim 1, wherein the controllable limiter is configured as a rail-like element with two lateral limiting walls.

4. The manually operated actuator according to claim 3, wherein the controllable limiter is configured as a U-shaped rail in cross-section with the two lateral limiting walls.

5. The manually operated actuator according to claim 1,
wherein the controllable limiter is controllably raisable and lowerable,
wherein the controllable limiter is configured to release the actuating lever in a first operating position, and
wherein the controllable limiter is configured to position the actuating lever between two lateral limiting walls in a second operating position and is configured to limit or prevent movement of the actuating lever in one direction.

6. The manually operated actuator according to claim 1, wherein an adjustment actuator is configured to raise and lower the controllable limiter.

7. The manually operated actuator according to claim 1 further comprising:
at least one controllable actuator, which is configured to exert a force on the actuating lever in order to influence resistive forces acting on the actuating lever during actuation of the actuating lever, in order to influence an actuation feel of the actuating lever; and
at least one transmission between the actuating lever and the at least one controllable actuator, which is equipped with a variably adjustable backlash, such that the backlash between the actuating lever and the at least one controllable actuator is controllably adjustable,

8. The manually operated actuator according to claim 1 further comprising:
two controllable actuators, which are configured to exert a force on the actuating lever in order to influence resistive forces acting on the actuating lever during actuation of the actuating lever in a first actuation direction and in a second actuation direction, in order to influence the actuation feel of the actuating lever.

9. A method for controlling a manually operated actuator for actuation of a transmission of a motor vehicle, the manually operated actuator comprising an actuator housing; and an actuating lever pivotably mounted in the actuator housing along a first actuation direction and along a second actuation direction, such that, in a first mode, the actuating lever is configured to be displaced in a shift gate along the first actuation direction and transversely to the shift gate in the second actuation direction, and, in a second mode, the actuating lever is configured to be displaced in the shift gate along the first actuation direction, and a displaceability transversely to the shift gate in the second actuation direction is limited or prevented by a controllable limiter, the method comprising:
controlling the controllable limiter to limit or prevent the displaceability of the actuating lever in the second actuation direction in the second mode.

10. The method according to claim 9, further comprising:
raising and lowering the controllable limiter;
releasing the actuating lever in a first operating position using the controllable limiter; and
positioning the actuating lever between two limiting walls in a second operating position and limiting or preventing movement of the actuating lever in one direction using the controllable limiter.

11. The method according to claim 9, further comprising:
carrying out switching between the first mode and the second mode using a switching element; and
raising or lowering the controllable limiter in a controlled manner based on the first mode or the second mode.
